(19) United States
(12) Patent Application Publication
(10) Pub. No.: US 2010/0314367 A1
(43) Pub. Date: Dec. 16, 2010

(54) METHODS AND SYSTEMS FOR LASER-SCRIBED LINE ALIGNMENT

(75) Inventors: Bassam SHAMOUN, Fremont, CA (US); Antoine P. MANENS, Saratoga, CA (US)

Correspondence Address: TOWNSEND AND TOWNSEND AND CREW LLP, TWO EMBARCADERO CENTER, EIGHTH FLOOR, SAN FRANCISCO, CA, 94111-3834, US

(73) Assignee: Applied Materials, Inc., Santa Clara, CA (US)

(21) Appl. No.: 12/814,327

(22) Filed: Jun. 11, 2010

Related U.S. Application Data
(60) Provisional application No. 61/186,735, filed on Jun. 12, 2009.

(51) Int. Cl. B23K 26/00

(52) U.S. Cl. 219/121.72; 219/121.67

(57) ABSTRACT

Methods and systems for laser-scribing lines within a controlled separation from previously-formed lines are provided. A laser-scribing method includes providing a workpiece having a plurality of previously-scribed lines, forming a first adjacent scribed line adjacent to a first previously-scribed line, using an imaging device to measure a position of a previously-scribed line, using the imaging device to measure a position of the first adjacent scribed line, and using the measured positions to control the formation of a second adjacent scribed line adjacent to a second previously-scribed line.

### CROSS-REFERENCES TO RELATED APPLICATIONS

This application claims the benefit of U.S. Provisional Patent Application No. 61/186,735, entitled “Methods and Systems For Laser-Scribed Line Alignment,” filed Jun. 12, 2009, (Attorney Docket No. 016301-094700US), the entire disclosure of which is hereby incorporated herein by reference.

### BACKGROUND

Various embodiments described herein relate generally to laser scribing, welding, or patterning of materials, and more particularly to systems and methods for forming features positioned relative to previously-formed features on a workpiece. These systems and methods can be particularly effective for laser scribing thin-film single junction and multi-junction solar cells.

Current methods for forming thin-film solar cells involve depositing or otherwise forming a plurality of layers on a substrate, such as a glass, metal or polymer substrate suitable to form one or more p-n junctions. An example thin solar cell includes a transparent-conductive-oxide (TCO) layer, a plurality of doped and undoped silicon layers, and a metal back layer. A series of laser-scribed lines is typically used to create individual cells connected in series. Examples of materials that can be used to form solar cells, along with methods and apparatus for forming the cells, are described, for example, in co-pending U.S. patent application Ser. No. 11/671,988, filed Feb. 6, 2007, entitled “MULTI-JUNCTION SOLAR CELLS AND METHODS AND APPARATUSES FOR FORMING THE SAME,” which is hereby incorporated herein by reference.

When a panel is being formed from a large substrate, a series of laser-scribed lines is typically used within each layer to delineate the individual cells. FIG. 1 diagrammatically illustrates an example solar-cell assembly 10 that includes scribed lines, for example, laser-scribed lines. The solar-cell assembly 10 can be fabricated by depositing a number of layers on a glass substrate 12 and scribing a number of lines within the layers. The fabrication process begins with the deposition of a TCO layer 14 on the glass substrate 12. A first set of lines 16 (“P1” lines) are then scribed within the TCO layer 14. A plurality of doped and undoped amorphous silicon (a-Si) layers 18 are then deposited on the TCO layer 14 and within the first set of lines 16. A second set of lines 20 (“P2” lines) are then scribed within the silicon layers 18. A metal layer 22 is then deposited on the silicon layers 18 and within the second set of lines 20. A third set of lines 24 (“P3” lines and “P3” isolation lines) are then scribed as illustrated.

To maximize the power output from a thin-film solar panel, it is important to minimize the surface area that is rendered, by the scribing process, useless for power production. To do this, the three lines, so called P1, P2 and P3, need to as close as possible to each other while still being separated by a minimum amount necessary for electrical insulation purposes. Therefore, when scribing P2 lines it is desirable to form the P2 lines adjacent to the P1 lines with a separation that is close as possible to the minimum required separation without violating the minimum required separation, and similarly for P3 lines relative to the P2 lines. However, the above described layering and scribing sequence lends itself to a process where each set of lines (P1, P2, and P3) is scribed in a different tool, which can present challenges in coordinating the placement of a set of lines formed in one tool with an existing set of lines that were formed in another tool.

Accordingly, it is desirable to develop systems and methods that provide for the accurate scribing of lines relative to previously-scribed lines, particularly with respect to scribed lines that were formed in a different tool. Further, it can also be seen that this need for better alignment or relative positioning between scribe lines or other features may also exist for welding or other patterning systems.

### BRIEF SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

Methods and related systems in accordance with many embodiments provide for forming features on a workpiece positioned relative to previously-formed features on the workpiece. These methods and related systems may be particularly effective for the fabrication of laser-scribed thin-film multi junction solar cells.

In a first aspect, a method for using a laser-scribing device to scribe a workpiece is provided. The method comprises providing a workpiece having a plurality of previously-scribed lines, forming a first adjacent scribed line adjacent to a first previously-scribed line, using an imaging device to measure a position of a previously-scribed line, using the imaging device to measure a position of the first adjacent scribed line, and using the measured positions to control the formation of a second adjacent scribed line adjacent to a second previously-scribed line.

In another aspect, a system for laser-scribing a workpiece having a plurality of previously-scribed lines is provided. The system comprises a laser operable to generate output able to remove material from the workpiece, a scanning device operable to control a position of the output from the laser relative to the workpiece, an imaging device configured to output image data in response to imaging a position of a scribed line of the workpiece, and a processor coupled with the scanning device and the imaging device. The processor comprises a tangible medium comprising instructions that when executed cause the processor to cause the formation of a first adjacent scribed line adjacent to a first previously-scribed line, process image data outputted by the imaging device to measure a position of a previously-scribed line, process image data outputted by the imaging device to measure a position of the first adjacent scribed line, and use the measured positions to control the formation of a second adjacent scribed line adjacent to a second previously-scribed line.

In another aspect, a method for forming a pattern on a workpiece by using a laser-scribing device is provided. The method comprises providing a workpiece having a plurality of previously-scribed lines, directing a laser beam to form a first adjacent scribed line at a first target separation from a first previously-scribed line, using an imaging device to determine an actual separation between the first previously-scribed line and the first adjacent line, and using difference between the first target separation and the determined actual separation to adjust a directing of the laser beam to form a second adjacent scribed line at a second target separation from a second previously-scribed line.

For a fuller understanding of the nature and advantages of the present invention, reference should be made to the ensuing detailed description and accompanying drawings. Other aspects, objects and advantages of the invention will be apparent from the drawings and detailed description that follows.

### BRIEF DESCRIPTION OF THE DRAWINGS

FIG. 1 illustrates laser-scribed lines in a thin-film solar-cell assembly.

FIG. 2 illustrates a perspective view of a laser-scribing system in accordance with many embodiments.

FIG. 3 illustrates an end view of a laser-scribing system in accordance with many embodiments.

FIG. 4 diagrammatically illustrates components of a laser assembly in accordance with many embodiments.

FIG. 5 illustrates the generation of multiple scan areas in accordance with many embodiments.

FIG. 6A diagrammatically illustrates the integration of an imaging device within a laser assembly in accordance with many embodiments.

FIG. 6B diagrammatically illustrates a laser assembly and an imaging device disposed external to the laser assembly in accordance with many embodiments.

FIG. 7 diagrammatically illustrates a set of scribed lines relative to a first and second laser assembly in accordance with many embodiments.

FIGS. 8A and 8B diagrammatically illustrates moving an imaging device in a forward and a reverse direction, respectively, relative to a workpiece to measure one or more scribed line and/or fiducial marker positions in accordance with many embodiments.

FIG. 8C diagrammatically illustrates a forward direction movement of an imaging device relative to a workpiece to measure one or more scribed line and/or fiducial marker positions and a forward direction scribing of a line adjacent to a first laser-scribed line, in accordance with many embodiments.

FIG. 8D diagrammatically illustrates a reverse direction movement of an imaging device relative to a workpiece to measure one or more scribed line and/or fiducial marker positions and a reverse direction scribing of a line adjacent to a second laser-scribed line, in accordance with many embodiments.

FIG. 8E diagrammatically illustrates a forward direction movement of an imaging device relative to a workpiece to measure one or more scribed line positions and a forward direction scribing of a line adjacent to a third laser-scribed line, in accordance with many embodiments.

FIG. 8F diagrammatically illustrates a reverse direction movement of an imaging device relative to a workpiece to measure one or more scribed line positions and a reverse direction scribing of a line adjacent to a fourth laser-scribed line, in accordance with many embodiments.

FIGS. 9A through 9F are simplified block diagrams listing operations associated with FIGS. 8A through 8F, respectively, in accordance with many embodiments.

FIG. 10 is a simplified block diagram illustrating a method of using a laser-scribing device to scribe a workpiece, in accordance with many embodiments.

FIG. 11 is a simplified block diagram illustrating a control system in accordance with many embodiments.

### DETAILED DESCRIPTION

Methods and systems in accordance with many embodiments relate generally to laser scribing, welding, or patterning of materials, and many embodiments relate more particularly to methods and systems for laser-scribed line alignment. Many embodiments may provide for more accurate alignment of a laser-scribed line with a previously-formed laser-scribed line by using an imaging device to measure one or more positions of a previously-formed laser-scribed line and one or more positions of a recently-formed laser-scribed line. The measurements obtained can be used to align the formation of a scribed line within a closely controlled separation with a previously-formed scribed line. Additionally, the measurements obtained can be used to calibrate measured positions with formation positions. Such calibration may provide for a more accurate ability to form a laser-scribed line relative to a previously formed laser-scribed line by compensating for drift between the positions of a laser-scribed line as measured by the imaging device and the formation positions of a laser-scribed line. These methods and systems can be particularly effective for laser scribing thin-film multi junction solar cells.

Laser-Scribing Devices

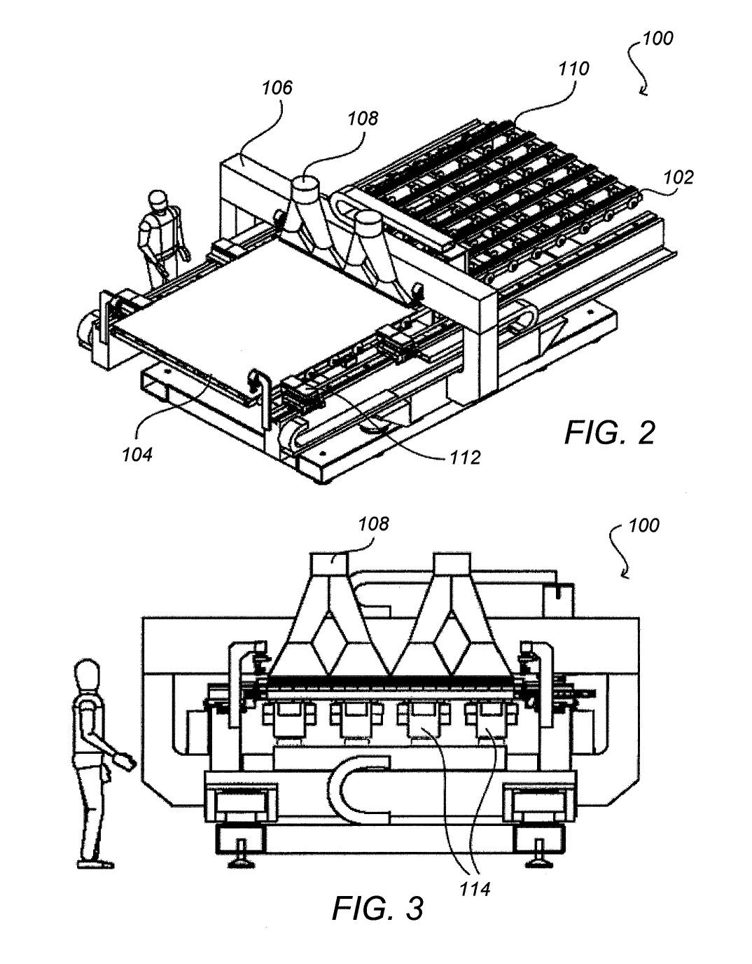

FIG. 2 illustrates a laser-scribing device 100 that can be used in accordance with many embodiments. The laser-scribing device 100 includes a substantially planar bed or stage 102, which will typically be level, for receiving and maneuvering a workpiece 104, such as a substrate having at least one layer deposited thereon. In many embodiments, a workpiece is able to move back and forth along a single directional vector at a rate of up to or greater than 2 m/s. In many embodiments, the workpiece will be aligned to a fixed orientation with the long axis of the workpiece substantially parallel to the motion of the workpiece in the laser-scribing device 100. The alignment can be aided by the use of an imaging device (e.g., a camera) that acquires marks on the workpiece. In the laser-scribing device 100, the lasers (shown in subsequent figures) are positioned beneath the workpiece and opposite a bridge 106 holding part of an exhaust mechanism 108 for extracting material ablated or otherwise removed from the substrate during the scribing process. The workpiece 104 can be loaded onto a first end of the stage 102 with the substrate side down (towards the lasers) and the layered side up (towards the exhaust). The workpiece can be received onto an array of rollers 110, although other bearing- or translation-type objects can be used to receive and translate the workpiece as known in the art. In the laser-scribing device 100, the array of rollers 110 all point in a single direction, along the direction of propagation of the workpiece, such that the workpiece can be moved back and forth in a longitudinal direction relative to the laser assembly. The device can include at least one controllable drive mechanism 112 for controlling a direction and translation velocity of the workpiece 104 on the stage 102. Further description about such a system and its use is provided in co-pending U.S. Provisional Application No. 61/044,390, which is incorporated by reference above.

FIG. 3 illustrates an end view of the laser-scribing device 100, illustrating a series of laser assemblies 114 used to scribe the layers of the workpiece. In the laser-scribing device 100, there are four laser assemblies 114, each including a laser and elements, such as lenses and other optical elements, used to focus or otherwise adjust aspects of the laser. The laser can be any appropriate laser operable to ablate or otherwise scribe at least one layer of the workpiece, such as a pulsed solid-state laser. As can be seen, a portion of the exhaust 108 is positioned opposite each laser assembly relative to the workpiece, in order to effectively exhaust material that is ablated or otherwise removed from the workpiece via the respective laser assembly. Each laser assembly actually produces two effective beams useful for scribing the workpiece. In order to provide the pair of beams, each laser assembly can include at least one beam splitting device.

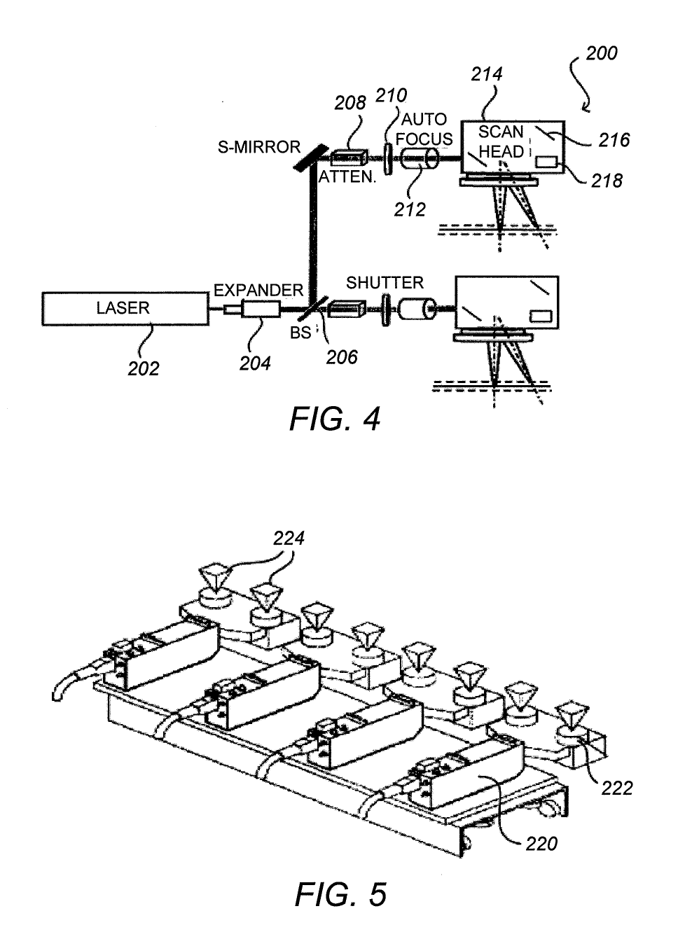

FIG. 4 illustrates basic elements of a laser assembly 200 that can be used in accordance with many embodiments, although it should be understood that additional or other elements can be used as appropriate. In the laser assembly 200, a single laser 202 generates a beam that is expanded using a beam expander 204 then passed to a beam splitter 206, such as a partially transmissive mirror, half-silvered mirror, prism assembly, etc., to form first and second beam portions. In the laser assembly 200, each beam portion passes through an attenuating element 208 to attenuate the beam portion, adjusting an intensity or strength of the pulses in that portion, and a shutter 210 to control the shape of each pulse of the beam portion. Each beam portion then also passes through an auto-focusing element 212 to focus the beam portion onto a scan head 214. Each scan head 214 includes at least one element capable of adjusting a position of the beam, such as a galvanometer scanner useful as a directional deflection mechanism. In many embodiments, this is a rotatable mirror able to adjust the position of the beam along a latitudinal direction, orthogonal to the movement vector of the workpiece, which can allow for adjustment in the position of the beam relative to the intended scribe position.

In many embodiments, each scan head 214 includes a pair of rotatable mirrors 216, or at least one element capable of adjusting a position of the laser beam in two dimensions (2D). Each scan head can include at least one drive element 218 operable to receive a control signal to adjust a position of the “spot” of the beam within a scan field and relative to the workpiece. In many embodiments, a spot size on the workpiece is on the order of tens of microns within a scan field of approximately 60 mm×60 mm, although various other dimensions are possible. While such an approach allows for improved correction of beam position on the workpiece, it can also allow for the creation of patterns or other non-linear scribe features on the workpiece. Further, the ability to scan the beam in two dimensions means that any pattern can be formed on the workpiece via scribing without having to rotate the workpiece. For example, FIG. 5 illustrates a perspective view of example laser assemblies in accordance with many embodiments. A pulsed beam from each laser 220 is split along two paths, each being directed to a 2D scan head 222. As shown, the use of a 2D scan head 222 results in a substantially square scan field for each beam, represented by a pyramid 224 exiting each scan head 222. By controlling a size and position of the square scan fields relative to the workpiece, the lasers 220 are able to effectively scribe any location on the substrate while making a minimal number of passes over the substrate. If the positions of the scan fields substantially meet or overlap, the entire surface could be scribed in a single pass of the substrate relative to the laser assemblies.

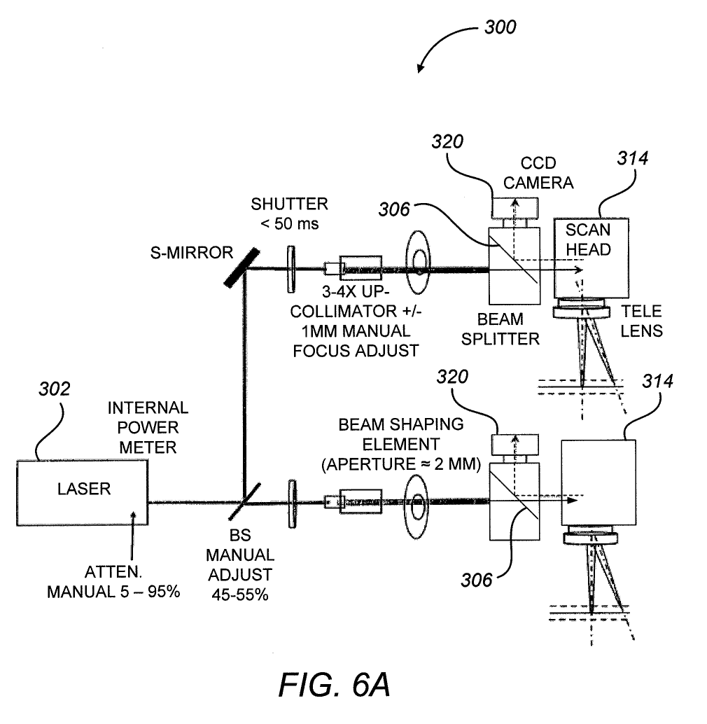

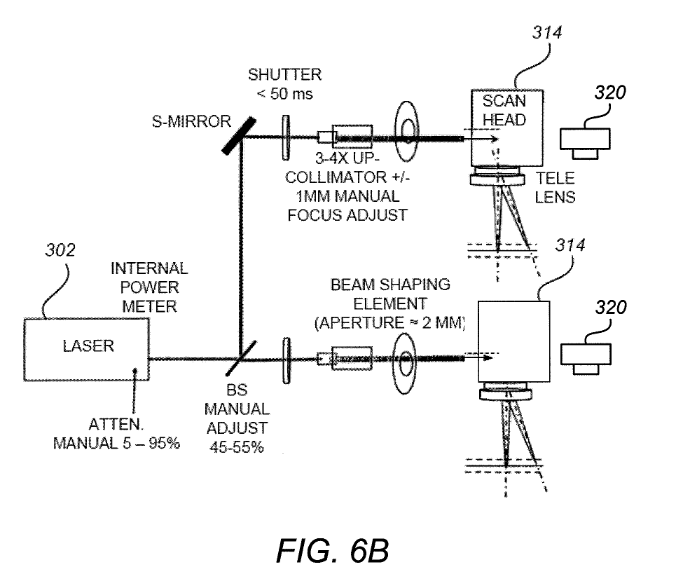

FIG. 6A diagrammatically illustrates a laser assembly 300 in accordance with many embodiments. The laser assembly 300 is similar to the previously discussed laser assembly 200 of FIG. 4, but further includes two imaging devices 320 (e.g., CCD cameras shown) integrated with the laser assembly 300 so that each of the imaging devices 320 can view the workpiece through an associated scanner 314. As shown, each of the imaging devices 320 can be integrated using a dichromatic beam splitter 306 so as provide the imaging device with a view direction that substantially corresponds with the direction along which a separate laser beam portion is provided to each of the scanners 314. As discussed above, although a range of relative positions can be practiced, an imaging device 320 can be integrated with the laser assembly 300 so that the center of its view and the output of the scribing laser 302 point at the same position on a workpiece targeted by the scanner 314.

As illustrated in FIG. 6B, an imaging device(s) 320 that is not integrated within a laser assembly can be used. For example, an imaging device(s) 320 and the scanners 314 can be mounted on a common movement stage so as to maintain a fixed relative offset between the imaging device(s) 320 and the scanners 314. An imaging device(s) 320 can also be mounted separate from the movement stage to which the scanners 314 are mounted (e.g., mounted to a fixed location, mounted to another movement stage).

Scribed-Line Placement and Measurement

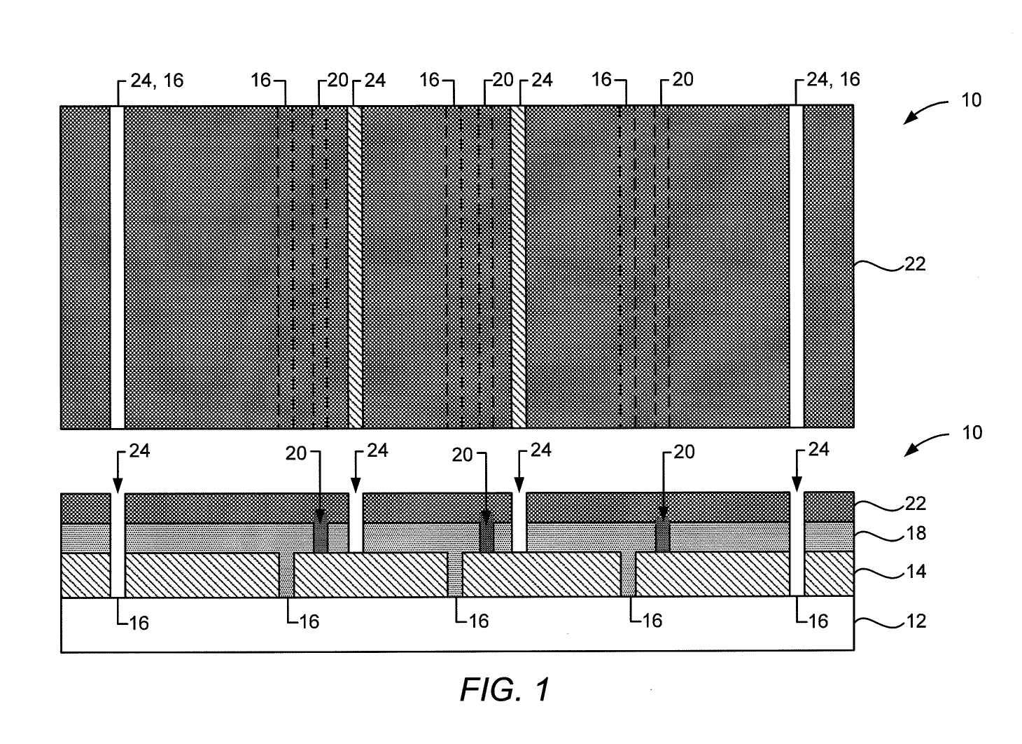

In many embodiments, various sets of laser-scribed lines (e.g., P1, P2, and P3 lines) are scribed into a workpiece by a number of laser-scribing devices. For example, a set of P1 lines (e.g., lines 16 shown in FIG. 1) may be scribed on a workpiece in a first laser-scribing device. The workpiece may then be transferred to a second laser-scribing device where a set of P2 lines (e.g., lines 20 shown in FIG. 1) are scribed adjacent to the set of P1 lines. The workpiece may then be transferred to a third laser-scribing device where a set of P3 lines (e.g., lines 24 shown in FIG. 1) are scribed adjacent to the set of P2 lines.

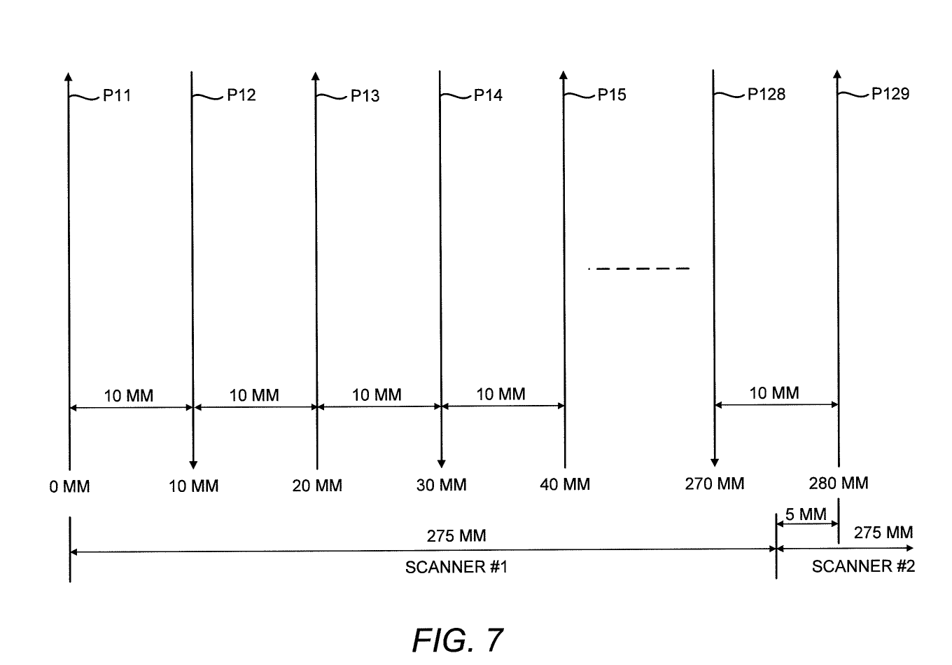

A set of P1 lines can be spaced at some desired spacing, for example, 10 mm as illustrated in FIG. 7. FIG. 7 diagrammatically illustrates the use of multiple scanners to form subsets of the P1 lines. In many embodiments, P1 lines 1 through 28 (i.e., P11 through P128) are formed by a first scanner (e.g., scanner number 1) and line 29 (i.e., P129) is formed by a second scanner (e.g., scanner number 2). The second scanner can be used to form additional P1 lines, for example, P1 lines 30 through 56 (not illustrated). Additional scanners can be used to form additional subsets, for example, a third scanner and a fourth scanner. It also should be understood that each scanner can form any appropriate number of P1 or other such lines according to any of a number of scan patterns. In many embodiments, each scanner is used to form individual P1 lines via a series of overlapping laser ablations while the workpiece is translated relative to the scanner. For example, the first scanner can be used to form line P11 in a forward direction (i.e., bottom to top in FIG. 7) while the workpiece is translated relative to the scanner such that the scanner moves in the forward direction relative to the workpiece. The direction of the workpiece can then be reversed and the first scanner deflected so as to form line P12 in a reverse direction (i.e., top to bottom in FIG. 7). A set of P1 lines can thus be formed through the use of one or more scanners to direct a series of overlapping laser ablations while the workpiece is translated in forward and reverse directions relative to the one or more scanners.

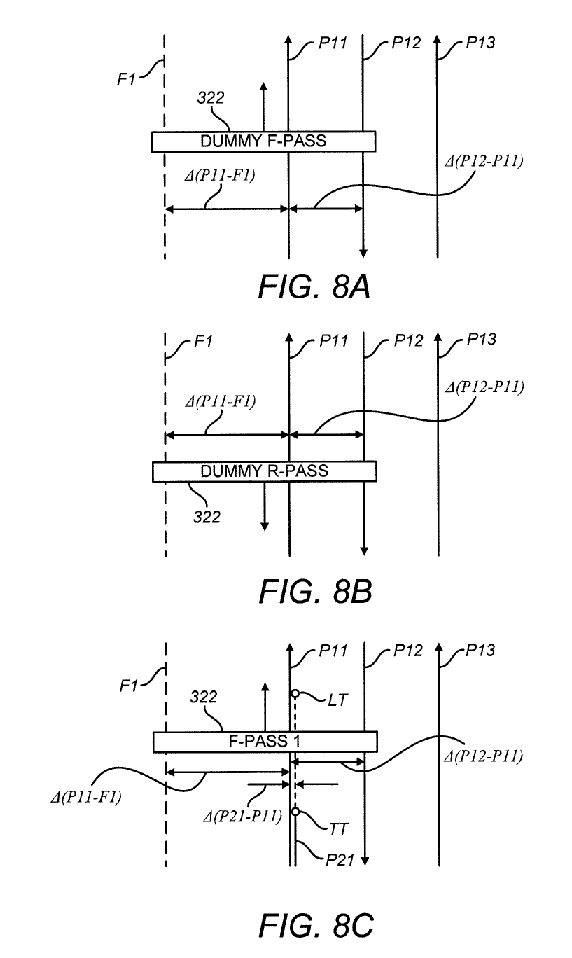

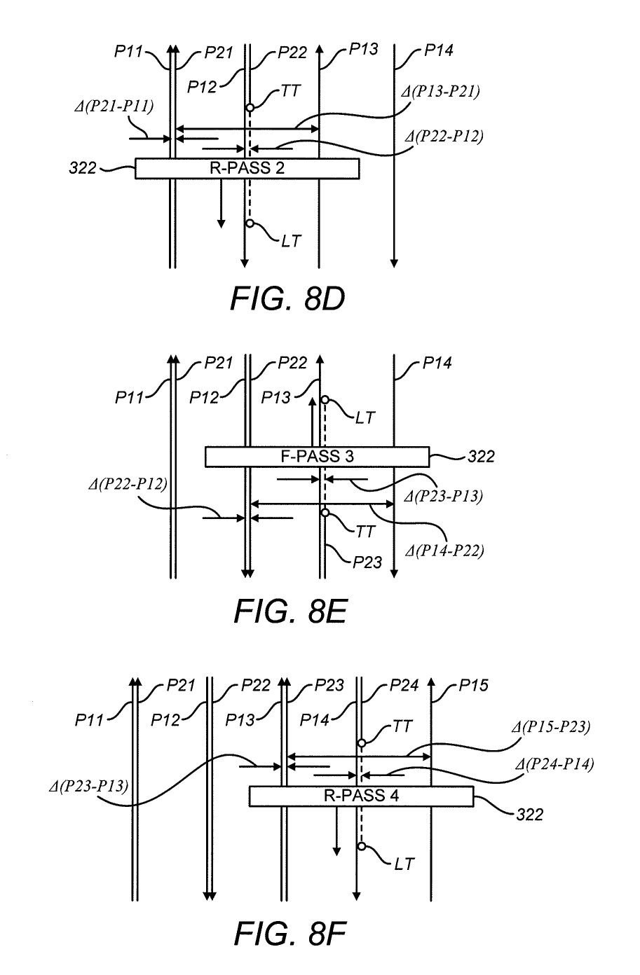

FIGS. 8A through 8F illustrate a number of approaches, in accordance with many embodiments, that can be used to measure one or more positions of a previously-formed laser-scribed line and one or more positions of a recently-formed laser-scribed line. The measurements obtained can be used to align the formation of a scribed line within a closely controlled separation with a previously-formed scribed line. Additionally, the measurements obtained can be used to calibrate measured positions with formation positions. By calibrating measured positions with formation positions, it may be possible to more closely align the formation of scribed lines with previously-formed scribed lines.

FIG. 8A diagrammatically illustrates moving an imaging device 322 (e.g., a line scan camera, for example, a linear CCD array with 4000 pixels (7 micron pixels); a region of interest of a two-dimensional imaging device; etc.) in a forward movement (e.g., bottom to top in FIG. 8A) relative to a workpiece to measure positions of one or more fiducial markers (e.g., F1) and/or one or more scribed lines (e.g., P11 and P12). In many embodiments, the relative movement between the imaging device 322 and the workpiece is generated by longitudinal movements (e.g., Y-direction) of the workpiece while the imaging device 322 is intermittently moved transversely (e.g., stepping in the X-direction) to position the imaging device 322 suitable for each longitudinal pass of the workpiece. The particular pixel(s) at which the one or more fiducial markers and/or the one or more scribed lines are registered can be used to determine the position(s) for these features. For example, calibration data providing a correspondence between pixel location and position can be used for this positional determination. The measured positions can be used during the formation of a subsequently-formed scribed line to more closely align the formation of the scribed line with a previously-formed scribed line. Due to variations that may occur between workpiece translation directions, it may be beneficial to measure the positions of a scribed line by moving the imaging device 322 in the same direction in which an adjacent scribed line will be formed. For example, if the scribed line adjacent to line P11 is to be formed in the forward direction (e.g., line P21 formed as illustrated in FIG. 8C), the positions measured using a forward movement of the imaging device 322 relative to the workpiece may provide for more accurate alignment of line P21 with line P11 than positions measured using a reverse movement of the imaging device 322 relative to the workpiece. This forward movement imaging pass (“DUMMY F-PASS”) is an optional step that can be omitted, for example, to avoid impact on throughput.

In many embodiments, the measured positions are used to construct an analytical model of a measured line that can be used to more closely align a subsequently-scribed line with the measured line. For example, interpolation can be used to predict positions of the measured line between measured positions. A mathematical model of the measured line can also be created by using known curve-fitting techniques to generate an equation for the measured line. In many embodiments, a mathematical model can range from a simple line equation to various curve equations, for example, a polynomial curve equation and/or an equation having an oscillatory function such as sin or cosine to account for positional variations along the measured line that may have resulted due to oscillatory vibrations of the laser-scribing device during the formation of the measured line. For example, when a measured line comprises an oscillatory component with a frequency of around 50 Hz, a measurement frequency of 200 Hz or greater will provide four or more data points per oscillation that can be used to fit a curve equation that includes an oscillatory function to the measured positions.

In many embodiments, the measured positions are used to determine a relative separation between two of the measured positions. For example, the measured positions can be used to determine one or more relative separations between the line P11 and the fiducial marker F1 (Δ(P11-F1)) and/or between the line P12 and the line P11 (Δ(P12-P11)).

In many embodiments, two fixed imaging devices are used to locate fiducial markers (e.g., one fixed imaging device is positioned to locate the fiducial marker F1 and another fixed imaging device is positioned to locate a fiducial marker disposed on the opposite side of the workpiece). The utilization of such dedicated fiducial marker imaging devices may increase throughput by eliminating separate passes used to locate the fiducial markers.

In many embodiments, calibration data providing a correspondence between two pixel locations of the imaging device and the actual distance between imaged features that would be registered at the two pixel locations can be used to determine the relative separation between the imaged features. For example, during the forward imaging movement of FIG. 8A, a location of the fiducial marker F1 would register at a first pixel location and an adjacent location of the P11 line would register at a second pixel location. The number of pixels separating the first and second pixel locations can be used in conjunction with calibration data that provides a correspondence between pixel separation and distance to determine Δ(P11-F1). The Δ(P12-P11) can be determined in a similar fashion.

The calibration data used to convert pixel separations to actual distances may be a function of the position of the imaging device relative to the imaged features. For example, due to the position of the imaging device relative to fiducial marker F1, line P11, and P12 in the forward pass shown in FIG. 8A, the pixel separation to actual separation conversion used for determining Δ(P12-P11) may be different from the conversion used for determining Δ(P11-F1). In many embodiments, the position of the imaging device relative to the measured lines from one imaging pass to another is substantially similar so that the same conversion between pixel separation and actual distance can be used for determining analogous separations.

FIG. 8B diagrammatically illustrates moving the imaging device 322 in a reverse movement (e.g., top to bottom in FIG. 8A) relative to a workpiece to measure positions of one or more fiducial markers (e.g., F1) and/or one or more scribed lines (e.g., P11 and P12). The positions measured during the reverse movement can be used in a similar fashion to the positions measured during the above discussed forward movement. For example, it may be beneficial to use the positions measured in the reverse direction during the formation of subsequently-formed scribed lines that are also formed in the reverse direction (e.g., line P22 formed as illustrated in FIG. 8D). One or more relative separations determined using positions measured during the reverse movement can be used in conjunction with the one or more separations determined using positions measured during the forward movement for a number of purposes, for example, for confirmation and/or supplementation of determined separations. This reverse movement imaging pass (“DUMMY R-PASS”) is an optional step that can be omitted, for example, to avoid impact on throughput.

As discussed above, the one or more relative separations can be determined using pixel separation to distance calibration data, for example, pixel separation data to distance calibration data appropriate for the position of the imaging device relative to the imaged features. In many embodiments, the relative position between the imaging device and the imaged features will be similar to the relative position of another pass, for example the relative position of the forward pass of FIG. 8A can be similar to the relative position for the reverse pass of FIG. 8B. In many embodiments, the same calibration data is used for passes having similar relative positions between the imaging device and the imaged features.

Measuring the relative separations between the scribed lines in each of the laser-scribing devices can be used to account for device-to-device variations in the relative separations that may occur. For example, variations in the relative separations can occur due to thermal expansion and/or contraction that occur due to workpiece temperature variations (e.g., temperature variations associated with the formation of a layer on the workpiece such as a silicon layer).

In addition to the measurement of relative separations between the scribed lines, absolute positions of the scribe lines can also be measured. The absolute position of the scribed lines can be measured in one or more of the laser-scribing devices and used for subsequent process and/or quality control. For example, such absolute position measurements can be used to determine device-to-device variations, which can be statistically analyzed (e.g., to determine whether such device-to-device variations are predictable (and to what level of accuracy), to identify trends, etc.).

FIG. 8C diagrammatically illustrates moving the imaging device 322 in a forward movement relative to a workpiece during a scribing pass in which a line P21 is scribed adjacent to line P11. In many embodiments, for example, where positions of P11 were measured during a previous movement (e.g., during the forward movement discussed above with reference to FIG. 8A), the line P21 is scribed using a leading target LT such that the imaging device can measure positions of line P21, as well as positions of one or more previously-formed features (e.g., fiducial marker F1, lines P11, P12). The measured positions can be used to determine one or more relative separations Δ(P11-F1), Δ(P21-P11), Δ(P12-P11). As discussed above, relative separations can be determined using pixel separation to distance calibration data, for example, calibration data corresponding to the position of the imaging device relative to the measured features. In many embodiments, for example, where positions of P11 were not measured during a previous movement, the line P21 is scribed using a trailing target TT such that the imaging device can measure positions of line P11 (as well a positions of other previously-formed features) that can be used to align the formation of line P21 with line P11. A leading target LT or a trailing target TT can be separated from the imaging device 322 such that reflections from the laser-ablation pulses do not interfere with the measurements of the imaging device 322, for example, by 100 mm in some embodiments. In many embodiments, there is only one imaging device (e.g., mounted on one side of the scanner) such that if a leading target LT is used during forward movements a trailing target TT would be used during reverse movements, and vice-versa. In many embodiments, two imaging devices are used such that a leading target LT and/or a trailing target TT are possible for both forward and reverse movements.

In many embodiments, the formation of the initial adjacent scribed line (e.g., line P21) can be accomplished using ablation-pulse target locations that were determined using an increased separation, for example, from anticipated nominal positions or from measured positions of the previously-formed scribed line (e.g., line P11). Such an increased separation can be used to account for unknown variations in positions of the previously-formed scribed line. For example, the actual positions of any given previously-scribed line may vary to some extent from its anticipated nominal positions. Additionally, where positions of the previously-scribed line have been measured by an imaging device, there may be some unknown variation between a position as measured by the imaging device and the position of a scanner necessary to direct a laser-ablation pulse to form a feature at a desired separation from the measured scribed line. Such an unknown variation can result from a number of sources, such as drift that may occur over time between a position of a feature as measured by an imaging device and the corresponding position of a scanner that would be necessary to subject the position to a laser-ablation pulse. At least for variations that do not change dramatically between the processing of workpieces, data from a previous workpiece can be used to reduce or substantially eliminate the amount of increased separation used by providing one or more recently determined correspondences between a measured position of a scribed line and a commanded position necessary to ablate a position at a desired separation from the scribed line. In many embodiments, data from a previous workpiece can be used to generate calibration parameters to match positions as measured by the imaging device with commanded positions necessary to ablate the measured positions.

FIG. 8D diagrammatically illustrates moving the imaging device 322 in a reverse movement relative to a workpiece during a scribing pass in which a line P22 is scribed adjacent to line P12. In many embodiments, for example, where positions of P12 were measured during a previous movement (e.g., during the reverse movement discussed above with reference to FIG. 8B, during the forward movement discussed above with reference to FIG. 8C), the line P22 can be scribed using a leading target LT such that the imaging device can measure positions of line P22, as well as positions of one or more previously-formed features (e.g., lines P11, P12, P13). The measured positions can be used to determine one or more relative separations between positions of scribed lines (e.g., Δ(P21-P11), Δ(P13-P21), Δ(P22-P12)). As discussed above, relative separations can be determined using pixel separation to distance calibration data, for example, calibration data corresponding to the position of the imaging device relative to the measured features. In many embodiments, the line P22 is scribed using a trailing target TT such that the imaging device can measure positions of line P12 (as well as positions of other previously-formed features) that can be used to align the formation of line P22 with line P12. In many embodiments, the formation of line P22 can be accomplished using an increased separation from line P12 as discussed above with respect to the formation of line P21 relative to P11. In many embodiments, one or more measured separations between line P12 and another scribed line (e.g., line P11) can be used in conjunction with one or more measured separations between line P21 and another scribed line (e.g., line P11) to determine how much of an offset from the locations targeted for the formation of line P21 is required so that line P22 is formed close to a desired separation from line P12. In many embodiments, one or more measured separations between line P21 and another scribed line can be used to update the above discussed calibration parameters.

FIG. 8E diagrammatically illustrates moving the imaging device 322 in a forward movement relative to a workpiece during a scribing pass in which a line P23 is scribed adjacent to line P13. In many embodiments, the line P23 is scribed using a leading target LT such that the imaging device can measure positions of line P23, as well as positions of one or more previously-formed features (e.g., lines P12, P22, P13, P14). The measured positions can be used to determine one or more relative separations between positions of scribed lines (e.g., Δ(P22-P12), Δ(P14-P22), Δ(P23-P13)). As discussed above, relative separations can be determined using pixel separation to distance calibration data, for example, calibration data corresponding to the position of the imaging device relative to the measured features. In many embodiments, the line P23 is scribed using a trailing target TT such that the positions of line P13 can be measured during the forward movement for use in aligning line P23 with line P13. In many embodiments, previously-measured separations between line P13 and line P21 are used to determine how much offset from the targeted locations used to form line P21 is required so that line P23 is formed close to a desired separation from line P13. The use of previously-measured separations between line P13 and line P21 may be beneficial in order to avoid potential sources of variations by using a reference line P21 having the same formation direction as line P23. Alternatively, previously-measured separations between line P13 and line P22 can be used to determine how much of an offset from the targeted locations used to form line P22 are required so that line P23 is formed close to a desired separation from line P13. In many embodiments, one or more measured separations between line P23 and another scribed line (e.g., line P13) and/or one or more measured separations between line P22 and another scribed line (e.g., line P12) are used to update the above discussed calibration parameters. In many embodiments, the above discussed calibration parameters are used in conjunction with measured positions of line P13 to determine the targeted locations used to form line P23 close to a desired separation from line P13.

FIG. 8F diagrammatically illustrates moving the imaging device 322 in a reverse movement relative to a workpiece during a scribing pass in which a line P24 is scribed adjacent to line P14. In many embodiments, the line P24 is scribed using a leading target LT such that the imaging device can measure positions of line P24, as well as positions of one or more previously-formed features (e.g., lines P13, P23, P14, P15). The measured positions can be used to determine one or more relative separations between positions of scribed lines (e.g., Δ(P23-P13), Δ(P15-P23), Δ(P24-P14)). As discussed above, relative separations can be determined using pixel separation to distance calibration data, for example, calibration data corresponding to the position of the imaging device relative to the measured features. In many embodiments, the relative position between the imaging device and the imaged features will be similar to the relative position of another pass, for example the position of the imaging device relative to the measured lines for the reverse pass of FIG. 8D can be similar to the position of the imaging device relative to the measured lines for the forward pass of FIG. 8E, which can be similar to the position of the imaging device relative to the measured lines for the reverse pass of FIG. 8F, etc. In many embodiments, the same calibration data is used for passes having similar relative positions between the imaging device and the imaged features. In many embodiments, the line P24 is scribed using a trailing target TT such that the positions of line P14 can be measured during the reverse movement for use in aligning line P24 with line P14. In many embodiments, previously-measured separations between line P14 and line P22 are used to determine how much offset from the targeted locations used to form line P22 is required so that line P24 is formed close to a desired separation from line P14. The use of previously-measured separations between line P14 and line P22 may be beneficial in order to avoid potential sources of variations by using a reference line P22 having the same formation direction as line P24. Alternatively, previously-measured separations between line P14 and line P23 can be used to determine how much of an offset from the targeted locations used to form line P23 are required so that line P24 is formed close to a desired separation from line P14. In many embodiments, one or more measured separations between line P24 and another scribed line (e.g., line P14) and/or one or more measured separations between line P23 and another scribed line (e.g., line P13) are used to update the above discussed calibration parameters. In many embodiments, the above discussed calibration parameters are used in conjunction with measured positions of line P14 to determine the targeted locations used to form line P24 close to a desired separation from line P14.

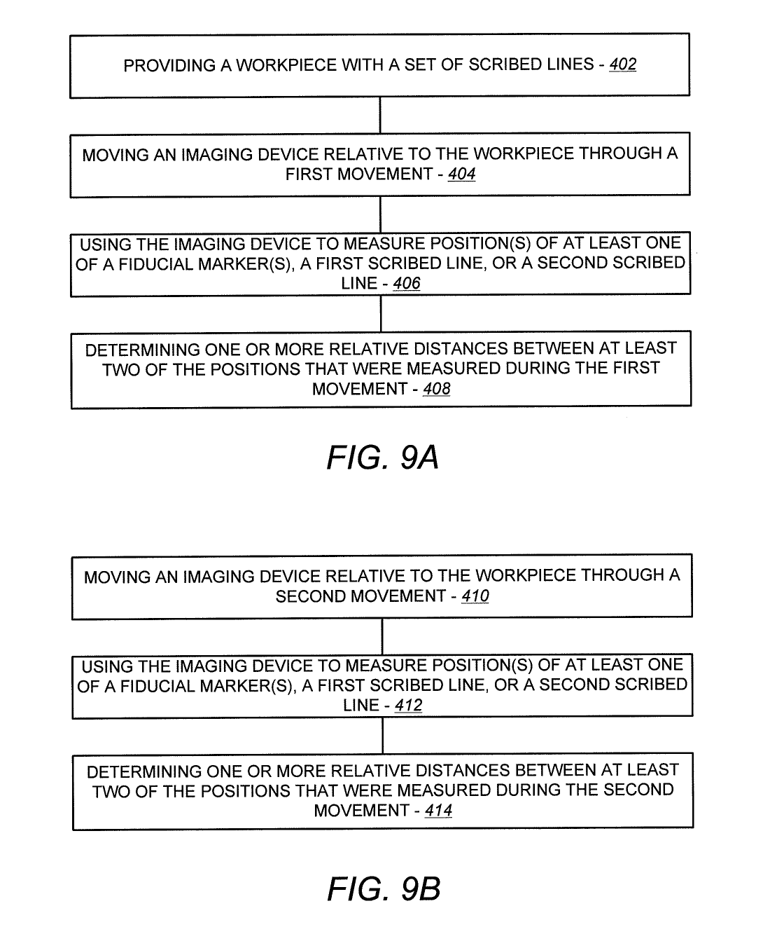

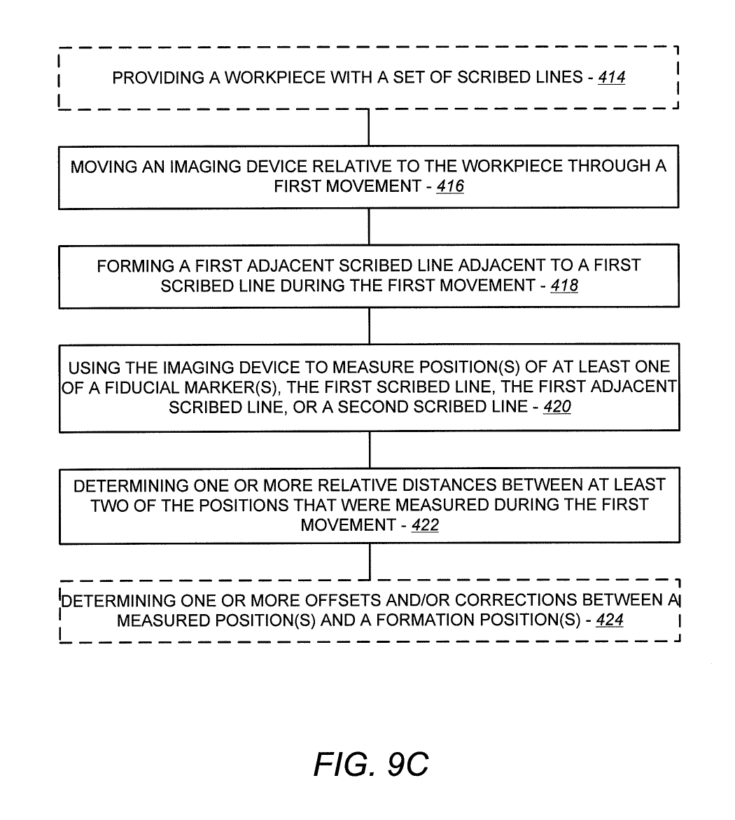

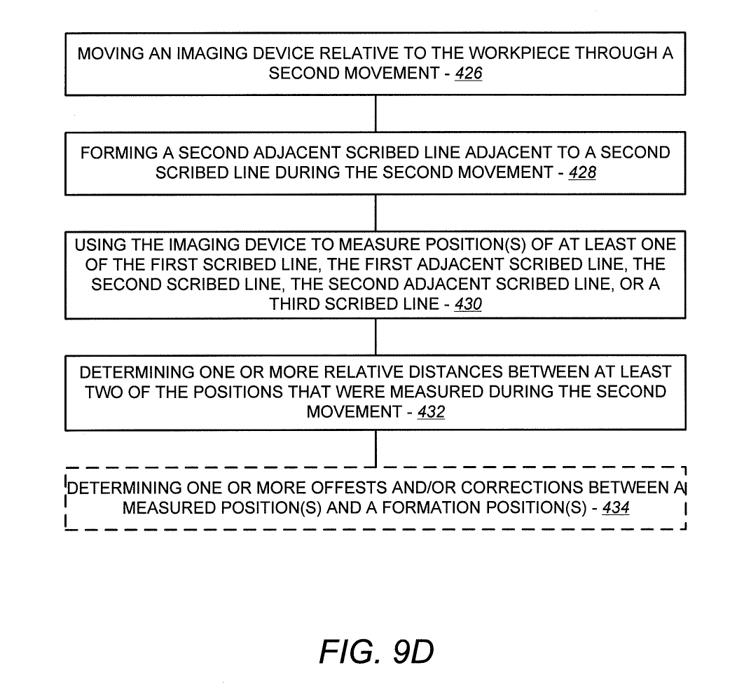

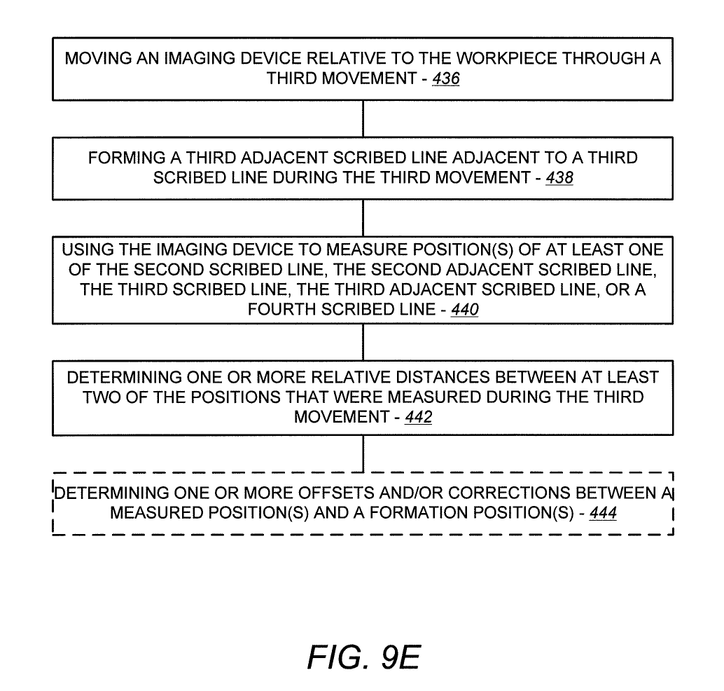

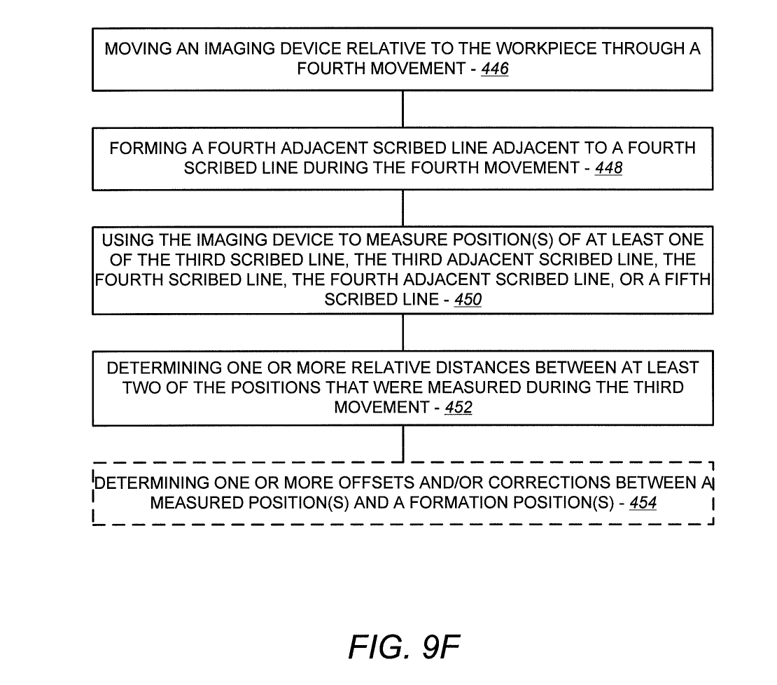

FIGS. 9A through 9F are simplified block diagrams stating operations associated with FIGS. 8A through 8F, respectively, that can be used to form scribed lines close to a desired separation from a previously-formed scribed line. In operation 402 (FIG. 9A), a workpiece with a set of scribed lines is provided (e.g., a set of scribed P1 lines as illustrated in FIG. 7). In operation 404, an imaging device is moved relative to the workpiece through a first movement (e.g., imaging device 322 moved in a forward direction as illustrated in FIG. 8A). In operation 406, the imaging device is used to measure positions of at least one of a fiducial marker(s), a first scribed line, or a second scribed line (e.g., fiducial marker F1, first scribed line P11, second scribed line P12). In operation 408, one or more relative distances are determined between positions that were measured during the first movement (e.g., Δ(P11-F1), Δ(P12-P11)).

FIG. 9B states operations similar to the operations of FIG. 9A, but with the imaging device being moved through another movement (e.g., the reverse direction illustrated in FIG. 8B as compared to the forward direction illustrated in FIG. 8A). In operation 410, an imaging device is moved relative to the workpiece through a second movement (e.g., imaging device 322 moved in a reverse direction as illustrated in FIG. 8B). In operation 412, the imaging device is used to measure positions of at least one of a fiducial marker(s), a first scribed line, or a second scribed line (e.g., fiducial marker F1, first scribed line P11, second scribed line P12). In operation 412, one or more relative distances are determined between positions that were measured during the second movement (e.g., Δ(P11-F1), Δ(P12-P11)).

FIG. 9C states operations that may or may not be preceded by the operations of FIG. 9A and/or FIG. 9B. In operation 414, if not already provided, a workpiece with a set of scribed lines is provided (e.g., a set of scribed P1 lines as illustrated in FIG. 7). In operation 416, an image device is moved relative to the workpiece through a first movement (e.g., imaging device 322 moved in a forward direction as illustrated in FIG. 8C). In operation 418, a first adjacent scribed line is formed adjacent to a first scribed line during the first movement (e.g., line P21 is scribed adjacent to line P11 using either a leading target LT or a trailing target TT as illustrated in FIG. 8C). In operation 420, the imaging device is used to measure positions of at least one of a fiducial marker(s), the first scribed line, the first adjacent scribed line, or a second scribed line (e.g., fiducial marker F1, first scribed line P11, first adjacent scribed line P21, second scribed line P12). In operation 422, one or more relative distances are determined between positions that were measured during the first movement (e.g., Δ(P11-F1), Δ(P21-P11), Δ(P12-P11)). In operation 424, one or more offsets and/or corrections between a measured position(s) and a formation position(s) are determined, for example, using Δ(P12-P11) and Δ(P21-P11) to determine how much to offset the targeted positions used to form P21 in order to form line P22 (formation illustrated in FIG. 8D). As a further example, the measured relative separations between line P21 and P11 (i.e., Δ(P21-P11)) can be compared with the targeted separations used during the formation of line P21 to determine one or more corrections necessary to have the targeted separations more closely match the actual resulting separations. Such corrections can take many forms, including, for example, simple offsets, linear transformations, non-linear transformations, etc.

FIG. 9D states operations similar to the operations of FIG. 9C, but with the imaging device being moved through another movement (e.g., the reverse direction illustrated in FIG. 8D as compared to the forward direction illustrated in FIG. 8C). In operation 426, an image device is moved relative to the workpiece through a second movement (e.g., imaging device 322 moved in a reverse direction as illustrated in FIG. 8D). In operation 428, a second adjacent scribed line is formed adjacent to a second scribed line during the second movement (e.g., line P22 is scribed adjacent to line P12 using either a leading target LT or a trailing target TT as illustrated in FIG. 8D). In operation 430, the imaging device is used to measure positions of at least one of the first scribed line, the first adjacent scribed line, the second scribed line, the second adjacent scribed line, or a third scribed line (e.g., first scribed line P11, first adjacent scribed line P21, second scribed line P12, second adjacent scribed line P22, third scribed line P13). In operation 432, one or more relative distances are determined between positions that were measured during the second movement (e.g., Δ(P21-P11), Δ(P13-P21), Δ(P22-P12)). In operation 434, one or more offsets and/or corrections between a measured position(s) and a formation position(s) are determined, for example, using Δ(P12-P11) and Δ(P13-P21) to determine how much to offset the targeted positions used to form P21 in order to form line P23 (formation illustrated in FIG. 8E). As a further example, the measured relative separations between line P21 and line P11 (i.e., Δ(P21-P11)) and/or between line P22 and line P12 (i.e., Δ(P22-P12)) can be compared with the targeted separations used during the formation of line P21 and/or line P22, respectively, to determine one or more corrections necessary to have the targeted separations more closely match the actual resulting separations.

FIG. 9E states operations similar to the operations of FIG. 9D, but with the imaging device being moved through another movement (e.g., the forward direction illustrated in FIG. 8E as compared to the reverse direction illustrated in FIG. 8D). In operation 436, an image device is moved relative to the workpiece through a third movement (e.g., imaging device 322 moved in a forward direction as illustrated in FIG. 8E). In operation 438, a third adjacent scribed line is formed adjacent to a third scribed line during the third movement (e.g., line P23 is scribed adjacent to line P13 using either a leading target LT or a trailing target TT as illustrated in FIG. 8E). In operation 440, the imaging device is used to measure positions of at least one of the second scribed line, the second adjacent scribed line, the third scribed line, the third adjacent scribed line, or a fourth scribed line (e.g., second scribed line P12, second adjacent scribed line P22, third scribed line P13, third adjacent scribed line P23, fourth scribed line P14). In operation 442, one or more relative distances are determined between positions that were measured during the third movement (e.g., Δ(P22-P12), Δ(P14-P22), Δ(P23-P13)). In operation 444, one or more offsets and/or corrections between a measured position(s) and a formation position(s) are determined, for example, using Δ(P22-P12) and Δ(P14-P22) to determine how much to offset the targeted positions used to form P22 in order to form line P24 (formation illustrated in FIG. 8F). As a further example, the measured relative separations between line P22 and line P12 (i.e., Δ(P22-P12)) and/or between line P23 and line P13 (i.e., Δ(P23-P13)) can be compared with the targeted separations used during the formation of line P22 and/or line P23, respectively, to determine one or more corrections necessary to have the targeted separations more closely match the actual resulting separations.

FIG. 9F states operations similar to the operations of FIG. 9E, but with the imaging device being moved through another movement (e.g., the reverse direction illustrated in FIG. 8F as compared to the forward direction illustrated in FIG. 8E). In operation 446, an image device is moved relative to the workpiece through a fourth movement (e.g., imaging device 322 moved in a reverse direction as illustrated in FIG. 8F). In operation 448, a fourth adjacent scribed line is formed adjacent to a fourth scribed line during the fourth movement (e.g., line P24 is scribed adjacent to line P14 using either a leading target LT or a trailing target TT as illustrated in FIG. 8F). In operation 450, the imaging device is used to measure positions of at least one of the third scribed line, the third adjacent scribed line, the fourth scribed line, the fourth adjacent scribed line, or a fifth scribed line (e.g., third scribed line P13, third adjacent scribed line P23, fourth scribed line P14, fourth adjacent scribed line P24, fifth scribed line P15). In operation 452, one or more relative distances are determined between at least two of the positions that were measured during the fourth movement (e.g., Δ(P23-P13), Δ(P15-P23), Δ(P24-P14)). In operation 454, one or more offsets and/or corrections between a measured position(s) and a formation position(s) are determined, for example, using Δ(P23-P13) and Δ(P15-P23) to determine how much to offset the targeted positions used to form P23 in order to form line P26 (formation not illustrated). As a further example, the measured relative separations between line P23 and line P13 (i.e., Δ(P23-P13)) and/or between line P24 and line P14 (i.e., Δ(P24-P14)) can be compared with the targeted separations used during the formation of line P23 and/or line P24, respectively, to determine one or more corrections necessary to have the targeted separations more closely match the actual resulting separations.

The above discussed operations (FIGS. 8A through 8F and 9A through 9F) can be repeated for subsequent scribed lines and the data obtained during the processing of a workpiece can be retained for use during the processing of a subsequent workpiece. For example, positional corrections determined during the processing of a workpiece can be used during the scribing of one or more scribe lines on a subsequent workpiece, for example, the corrections determined for scribing the first and second adjacent scribe lines (e.g., P21 shown in FIG. 8C and line P22 shown in FIG. 8D) can be used to reduce the amount of extra separation added during the formation of these lines.

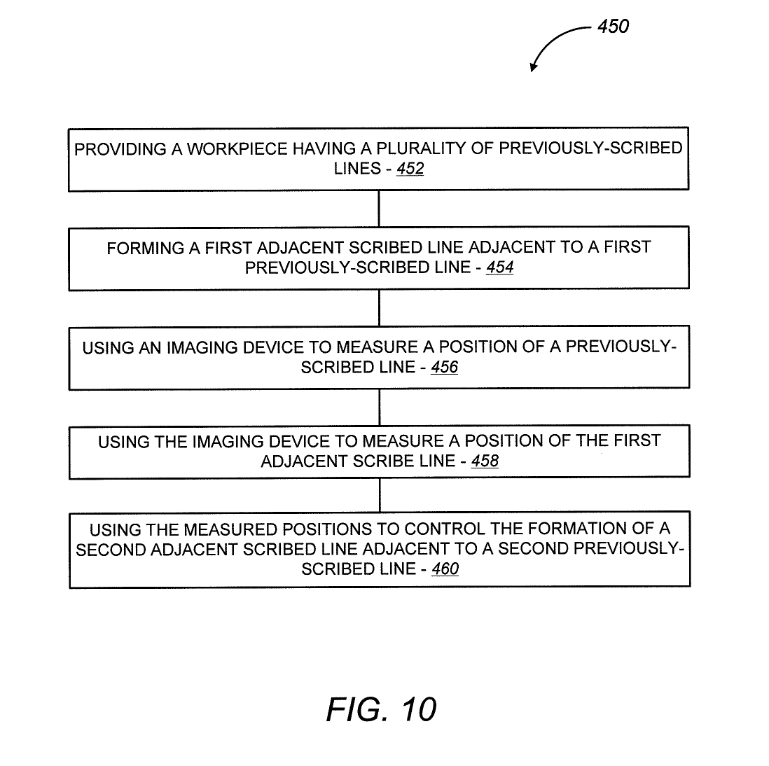

FIG. 10 is a simplified block diagram illustrating a method 450 that can be used to control the formation of a scribed-line adjacent to a previously-scribe line, in accordance with many embodiments. In operation 452, a workpiece is provided having a plurality of previously-scribed lines. In operation 454, a first adjacent scribed line is formed adjacent to a first previously-scribed line. In operation 456, an imaging device is used to measure a position of a previously-scribed line. In operation 458, the imaging device is used to measure a position of the first adjacent scribed line. In operation 460, the measured positions are used to control the formation of a second adjacent scribed line adjacent to a second previously-scribed line.

Control Systems

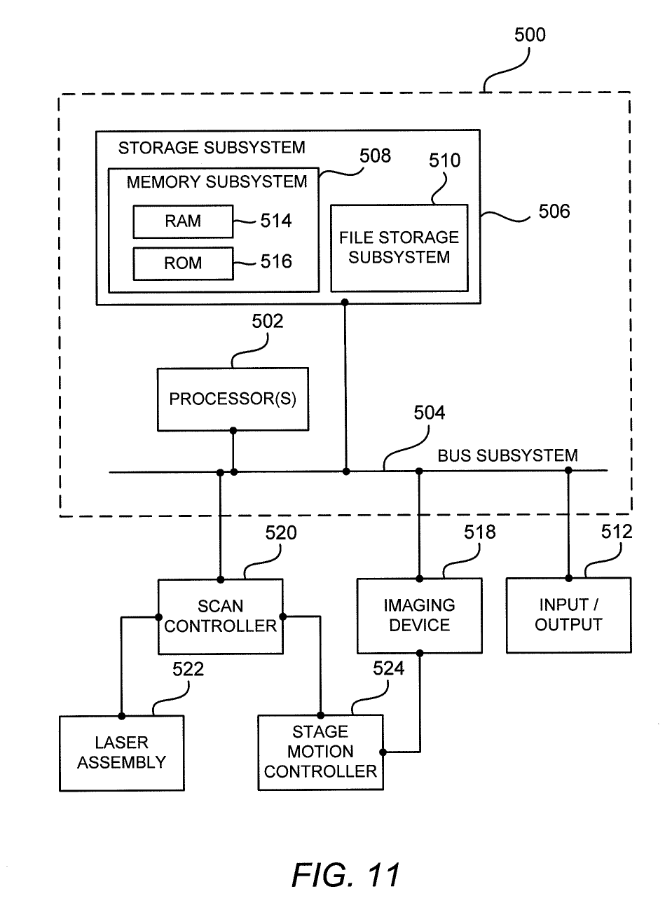

FIG. 11 is a simplified block diagram of a control system 500 that can be used in accordance with many embodiments. Control system 500 can include at least one processor 502, which can communicate with a number of peripheral devices via bus subsystem 504. These peripheral devices can include a storage subsystem 506 (memory subsystem 508 and file storage subsystem 510) and a set of user interface input and output devices 512.

The user interface input devices can include a keyboard and may further include a pointing device and a scanner. The pointing device can be an indirect pointing device such as a mouse, trackball, touchpad, or graphics tablet, or a direct pointing device such as a touch screen incorporated into the display. Other types of user interface input devices, such as voice recognition systems, are also possible.

User interface output devices can include a printer and a display subsystem, which can include a display controller and a display device coupled to the controller. The display device can be a cathode ray tube (CRT), a flat-panel device such as a liquid crystal display (LCD), or a projection device. The display subsystem can also provide non-visual display such as audio output.

Storage subsystem 506 can maintain basic programming and data constructs that can be used to control a patterning device. In many embodiments, storage subsystem 506 comprises a memory subsystem 508 and file storage subsystem 510.

Memory subsystem 508 typically includes a number of memories including a main random access memory (RAM) 514 for storage of instructions and data during program execution and a read only memory (ROM) 516 in which fixed instructions are stored.

File storage subsystem 510 provides persistent (non-volatile) storage for program and data files, and typically includes at least one hard disk drive and at least one disk drive (with associated removable media). There may also be other devices such as a CD-ROM drive and optical drives (all with their associated removable media). Additionally, the system may include drives of the type with removable media cartridges. One or more of the drives may be located at a remote location, such as in a server on a local area network or at a site on the Internet's World Wide Web.

In this context, the term “bus subsystem” is used generically so as to include any mechanism for letting the various components and subsystems communicate with each other as intended. With the exception of the input devices and the display, the other components need not be at the same physical location. Thus, for example, portions of the file storage system could be connected via various local-area or wide-area network media, including telephone lines. Bus subsystem 504 is shown schematically as a single bus, but a typical system has a number of buses such as a local bus and one or more expansion buses (e.g., ADB, SCSI, ISA, EISA, MCA, NuBus, or PCI), as well as serial and parallel ports.

In many embodiments, the bus subsystem 504 is used to couple system components with the processor 502. For example, an imaging device 518 can be coupled with the processor via the bus subsystem 504 in order to transfer image data to the processor 502. A scan controller 520 can be coupled with the processor via the bus subsystem 504 in order to receive positional data and/or corrections to be used during the formation of scribed lines. In many embodiments, the scan controller is coupled with one or more laser assemblies 522 and a stage motion controller 524 to control the targeting of laser ablations and the motion of the workpiece relative to the one or more laser assemblies, respectively. In many embodiments, the imaging device 518 is coupled with the stage motion controller 524 so as to receive a trigger signal (e.g., a position-based trigger signal) from the stage motion controller 524.

The above-described methods and systems can be used to account for skewed and/or non-linear laser-scribed lines. For example, as little as two location measurements can be made and used to determine a slope for a laser-scribed line. Additional numbers of measurements can also be made and used to determine non-linear variations of a scribed line. For example, measurements can be made at three or more (e.g., 130, 400) points along a scribed line to more fully characterize the shape of the scribed line. Linear interpolation and/or curve-fitting can be used to predict locations of the line in-between where measurements are made. Such multiple measurements can be made at controlled intervals (e.g., at a 100 hz repetition rate, at a 400 hz repetition rate, etc.). The determined slope or shape of the laser-scribed line can be used during the formulation of subsequently-scribed adjacent laser-scribed lines so as to better control a desired separation between the adjacent scribed lines.

It is understood that the examples and embodiments described herein are for illustrative purposes and that various modifications or changes in light thereof will be suggested to persons skilled in the art and are to be included within the spirit and purview of this application and the scope of the appended claims. Numerous different combinations are possible, and such combinations are considered to be part of the present invention.

What is claimed is:

1. A method for using a laser-scribing device to scribe a workpiece, the method comprising:
providing a workpiece having a plurality of previously-scribed lines;
forming a first adjacent scribed line adjacent to a first line of the previously-scribed lines;
using an imaging device to measure a position of one of the previously-scribed lines;
using the imaging device to measure a position of the first adjacent scribed line; and
using the measured positions to control the formation of a second adjacent scribed line adjacent to a second line of the previously-scribed lines.

2. The method of claim 1, further comprising moving the imaging device through a movement relative to the workpiece.

3. The method of claim 2, wherein moving the imaging device through a movement comprises moving the imaging device in a direction substantially parallel to one of the previously-scribed lines.

4. The method of claim 2, wherein said forming a first adjacent scribe line occurs during said moving the imaging device.

5. The method of claim 1, wherein the second adjacent scribed line is formed in substantially the same direction as the first adjacent scribed line is formed.

6. The method of claim 1, wherein the measured position of one of the previously-scribed lines comprises a measured position of the second line of the previously-scribed lines.

7. The method of claim 6, wherein said using the measured positions comprises generating a separation between the second line of the previously-scribed lines and the first adjacent scribed line.

8. The method of claim 1, wherein said using the measured positions comprises generating one or more calibration parameters providing a correspondence between one or more measured positions and one or more formation positions.

9. The method of claim 8, further comprising using one or more calibration parameters generated from one or more previous workpieces to control the formation of the first adjacent scribed line.

10. The method of claim 2, further comprising:
moving an imaging device through a second movement relative to the workpiece;
using the imaging device to measure a position of the second adjacent scribed line; and
using the measured position of the second adjacent scribed line to control the formation of a third adjacent scribe line adjacent to a third line of the previously-scribed lines.

11. The method of claim 10, wherein the formation of the second adjacent scribed line occurs during said moving an imaging device through a second movement relative to the workpiece.

12. The method of claim 10, wherein the third adjacent scribed line is formed in substantially the same direction as the second adjacent scribed line is formed.

13. A system for laser-scribing a workpiece having a plurality of previously-scribed lines, the system comprising:
a laser operable to generate output able to remove material from the workpiece;
a scanning device operable to control a position of the output from the laser relative to the workpiece;
an imaging device configured to output image data in response to imaging a position of a scribed line of the workpiece; and
a processor coupled with the scanning device and the imaging device, the processor comprising a tangible medium comprising instructions that when executed cause the processor to:
cause the formation of a first adjacent scribed line adjacent to a first line of the previously-scribed lines,
process image data outputted by the imaging device to measure a position of one of the previously-scribed lines,
process image data outputted by the imaging device to measure a position of the first adjacent scribed line, and
use the measured positions to control the formation of a second adjacent scribed line adjacent to a second line of the previously-scribed lines.

14. The system of claim 13, wherein the second adjacent scribed line if formed in substantially the same direction as the first adjacent scribed line is formed.

15. The system of claim 13, wherein the system is configured to produce relative movement between the workpiece and the imaging device, and wherein the imaging device is configured to output image data in response to imaging the workpiece during relative movement between the workpiece and the imaging device.

16. The system of claim 15, further comprising a workpiece stage operable to translate the workpiece along a translation direction relative to the imaging device and the scanning device.

17. The system of claim 16, further comprising an optics stage operable to translate the imaging device and the scanning device laterally relative to the translation direction of the workpiece stage.

18. The system of claim 13, wherein the imaging device comprises a linear charge-coupled-device (CCD) array.

19. The system of claim 13, wherein the instructions when executed cause the processor to:
process image data outputted by the imaging device to measure a position of the second line of the previously-scribed lines;
generate a separation between the second line of the previously-scribed lines and the first adjacent scribed line; and
use the separation to control the formation of the second adjacent scribed line adjacent to the second line of the previously-scribed lines.

20. The system of claim 13, wherein the instructions when executed cause the processor to use the measured positions to generate one or more calibration parameters providing a correspondence between one or more measured positions and one or more formation positions.

21. The system of claim 20, wherein the instructions when executed cause the processor to use one or more calibration parameters generated from one or more previous workpieces to control the formation of the first adjacent scribed line.

22. The system of claim 13, wherein the instructions when executed cause the processor to:
process image data outputted by the imaging device to measure a position of the second adjacent scribed line; and
use the position of the second adjacent scribed line to control the formation of a third adjacent scribed line adjacent to a third line of the previously-scribed lines.

23. The system of claim 22, wherein the third adjacent scribed line is formed in substantially the same direction as the second adjacent scribed line.

24. A method for forming a pattern on a workpiece by using a laser-scribing device, the method comprising:
providing a workpiece having a plurality of previously-scribed lines;
directing a laser beam to form a first adjacent scribed line at a first target separation from a first line of the previously-scribed lines;
using an imaging device to determine an actual separation between the first line of the previously-scribed lines and the first adjacent line; and
using difference between the first target separation and the determined actual separation to adjust a directing of the laser beam to form a second adjacent scribed line at a second target separation from a second line of the previously-scribed lines.
